(19) United States
(12) Patent Application Publication
(10) Pub. No.: US 2008/0110574 A1
(43) Pub. Date: May 15, 2008

(54) Sealing and cutting device for pocket coil row

(76) Inventor: Hiroyuki Etoh, Matsuura-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/594,741

(22) Filed: Nov. 9, 2006

(51) Int. Cl. B29C 65/08

(52) U.S. Cl. 156/516

(57) ABSTRACT

A manufacturing method for efficiently cutting a pocket coil spring row which is incorporated and used in a chair, sofa, or bed mattress into lengths suitable for the use without waste of the material is provided wherein a method for double-sealing a separating portion between adjacent pocket coil springs at an arbitrary length position of a serial pocket coil spring row by means of ultrasonic welding or impulse welding and cutting a portion between the double seals with a cutter knife is provided.

### BACKGROUND OF THE INVENTION

1. Field of the Invention

The present invention relates to a sealing and cutting device for a pocket coil row which efficiently cuts a pocket coil spring row to be incorporated and used in furniture such as a chair or a sofa or bedding such as a bed mattress into lengths suitable for the use without waste.

2. Description of the Related Art

Conventionally, as shown by the reference numeral 4 in FIG. 10 and also shown in U.S. Pat. No. 5,792,309, a method is employed in which when forming a pocket coil spring row, an empty pocket part that contains no coil spring is formed at a position of a length suitable for the use, and this empty pocket part is cut. However, this method wastes nonwoven cloth at the empty pocket part, and as the number of empty pocket parts increases, the capacity of production lowers.

In view of the above-described point, an object of a sealing and cutting device for a pocket coil row according to the invention is not to form the empty pockets that contain no coil spring to eliminate the waste of nonwoven cloth and increase the capacity of production.

### SUMMARY OF THE INVENTION

To achieve the object, the sealing and cutting device for a pocket coil row according to the invention seals and cuts a serial pocket coil row formed in a row in which coil springs are housed one by one in each of connected cylinders in pocket shapes made of nonwoven cloth or fabric every arbitrarily preset number of cylinders, characterized by: sealing means for double-sealing, cutting means for cutting a portion between the double seals by moving a cutting blade, and conveying means for conveying the pocket coil row.

In addition, according to the sealing and cutting device of the invention, the sealing means is an ultrasonic welder having a horn with a narrow groove for passage of a cutting blade, the sealing means is provided with an impulse heater wire on both sides of a cutting blade running line, a converter horn of the ultrasonic welder has a mechanism that moves up and down by about ½ or more of the coil spring diameter, the ultrasonic welder includes an upper die and a lower die and the lower die has a mechanism that moves up and down by about ½ or more of the coil spring diameter, or the ultrasonic welder includes an upper die and a lower die and the lower die is divided into two and the cutting blade is movable at the dividing center.

According to a conventional method, to prevent popping-out of coil springs described above, an empty pocket 4 that contains no coil spring is formed as shown in FIG. 8 and FIG. 10 and the center of the empty pocket is set as a cutting line 7 to prevent popping-out of the coil springs, however, this method has great disadvantages such that the material is wasted and the production efficiency lowers, however, the present invention solves these problems at one time.

### BRIEF DESCRIPTION OF THE DRAWINGS

FIG. 1 is a side view schematically showing an ultrasonic sealing and cutting device for cutting a pocket coil spring row into determined sizes;

FIG. 2 is an enlarged side view of a major part of the invention of FIG. 1;

FIG. 3 is a front view schematically showing an ultrasonic sealing and cutting device for cutting a pocket coil spring row into determined sizes;

FIG. 4 is an enlarged side view of a major part of the invention schematically showing an impulse sealing and cutting device for cutting a pocket coil spring row into determined sizes;

FIG. 5 is a front view schematically showing the impulse sealing and cutting device for cutting a pocket coil spring row into determined sizes;

FIG. 6 is an enlarged side view of a portion double-sealed and cut of a pocket coil spring row;

FIG. 7 is a top view of the portion double-sealed and cut of a pocket coil spring row;

FIG. 8 is a top view of a portion of a pocket coil spring row cut by the conventional method;

FIG. 9 is a perspective view showing a position to be double-sealed and cut of a pocket coil spring row; and

FIG. 10 is a perspective view showing a position to be cut of a pocket coil spring row by the conventional method.

### DETAILED DESCRIPTION OF THE PREFERRED EMBODIMENTS

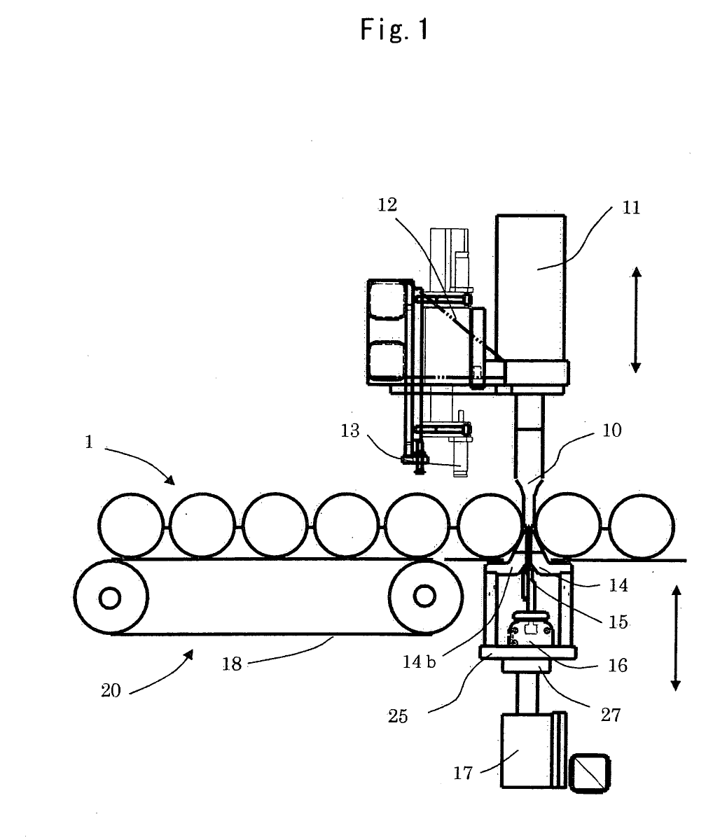

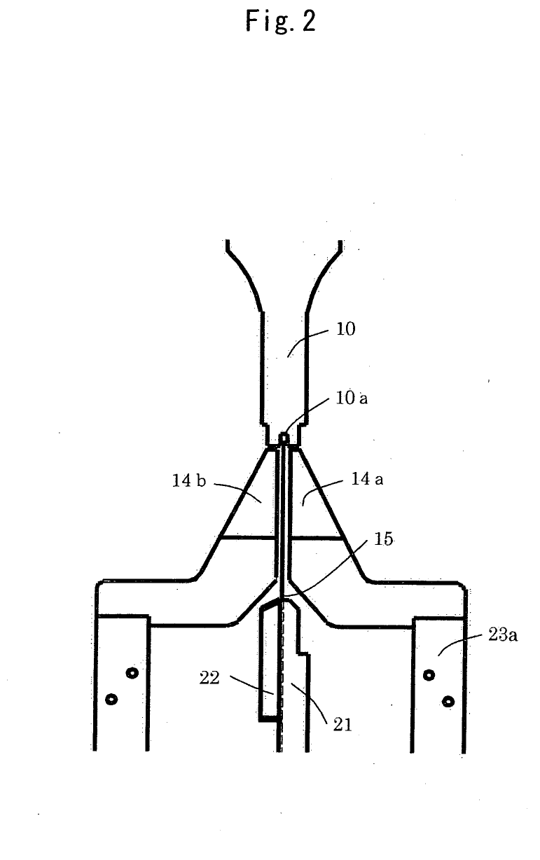

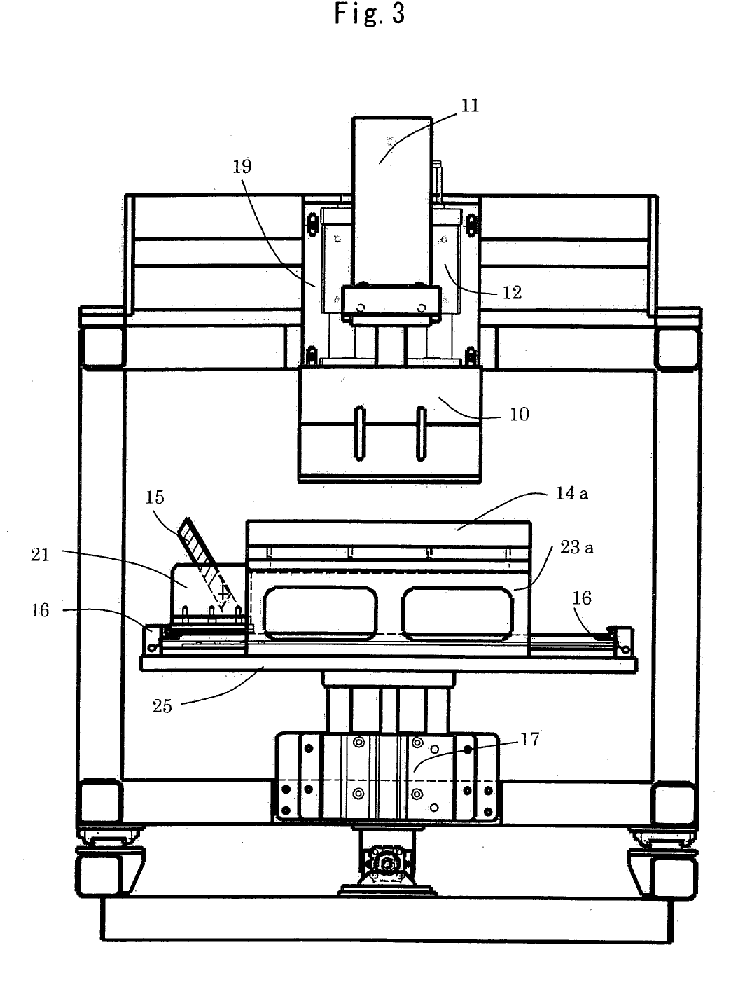

An embodiment of the invention will be described with reference to the drawings. FIG. 1 is a side view schematically showing a device equipped with an ultrasonic welding and sealing device, FIG. 2 is an enlarged view of a major part of FIG. 1, and FIG. 3 is a front view thereof.

The reference numeral 1 in the drawings denotes a serial pocket coil spring row, and the reference numeral 20 in the drawings denotes a conveyor for conveying the serial pocket coil spring row.

FIG. 1 and FIG. 2 show a state in that a horn 10 is at a lowered position and a pair of left and right anvils 14a and 14b are at raised positions, double sealing is performed by ultrasonic waves, and a portion between the double seals is cut.

FIG. 3 shows a state in that the horn 10 is at a raised position and the anvils 14a and 14b are at lowered positions, the distance between the lower surface of the horn 10 and the upper surfaces of the anvils 14a and 14b is set to be substantially not less than the diameter of the pocket coil spring so that the pocket coil spring row 1 passes through this space.

The ultrasonic device is composed of a converter 11, the horn 10, and a power supply (not shown).

The converter 11 and the horn 10 are anchored by screws, and the converter 11 is connected to the power supply (not shown) by a cable.

The converter 11 is anchored to a sliding portion of a cylinder 12 and structured to be movable up and down, and its vertical movement amount is set to be substantially not less than ½ of the pocket coil spring diameter so as not to inhibit the conveyance of the pocket coil spring row 1.

On the lower end portion of the horn 10, a groove 10a through which a cutter knife 15 passes is formed.

Concerning the anvils, the right anvil 14a and the left anvil 14b are disposed symmetrically so as to allow the cutter knife 15 to pass through.

The right anvil 14a is anchored to a supporting plate 23a, and the supporting plate 23a is fixed to a cylinder base 25.

The left anvil 14b is anchored to the supporting plate 23b, and the supporting plate 23b is fixed to the cylinder base 25.

The cutter knife 15 is fixed to a cutter knife attaching base 21 by a cutter knife holder 22, and the cutter knife attaching base 21 is fixed to a slider base of a rodless cylinder 16.

The cutter knife 15 is structured to run between the right anvil 14a and the left anvil 14b.

The cylinder base 25 is fixed to the cylinder rod base 27 of the cylinder 17 and structured to move up and down, and its vertical movement amount is set to be not less than about ½ of the pocket coil spring diameter so as not to disturb conveyance of the pocket coil spring row 1.

When the horn 10 is at the raised position and the anvils 14a and 14b are at the lowered positions, the conveyor 20 rotates to convey the pocket coil spring row 1 on a conveyor belt 18.

At this time, the number of springs is sensed by a sensor 13, and the conveyor 20 is stopped at a number preset in the counter.

Next, the horn 10 is lowered, and simultaneously, the anvils 14a and 14b are raised, and nonwoven cloth between the pocket coil spring and the pocket coil spring adjacent to each other is sandwiched by the lower surface of the horn 10 and the upper surfaces of the anvils 14a and 14b.

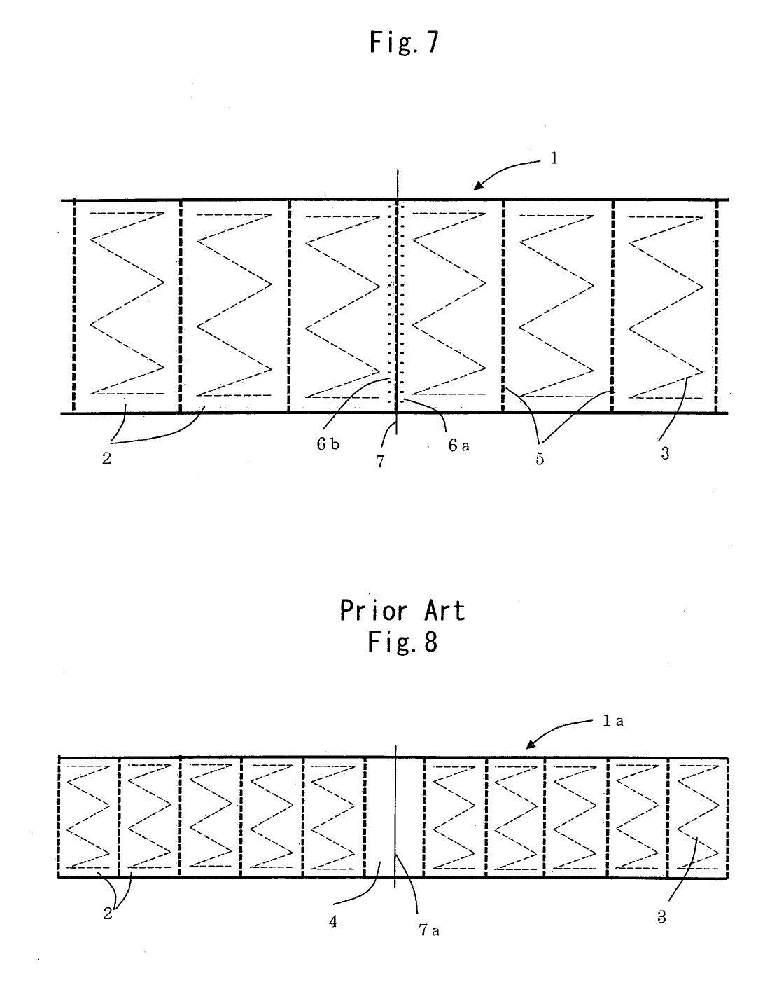

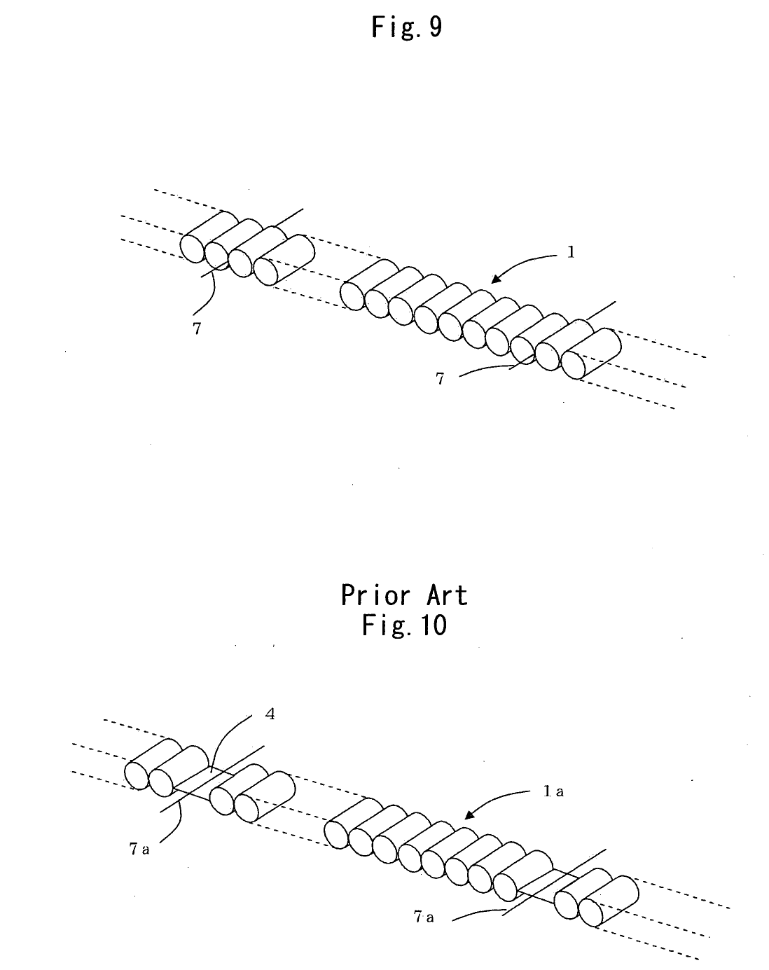

Thereafter, by turning the power supply of the ultrasonic device ON to make the horn 10 to generate ultrasonic waves, right sealing 6a and left sealing 6b are simultaneously performed as shown in FIG. 7.

Substantially simultaneously with this, the rodless cylinder 16 works to move the cutter knife 15, and this cutter knife 15 cuts a cutting line 7 between the right sealing 6a and the left sealing 6b.

Therefore, the left pocket coil of the pocket coil springs adjacent to each other across the cutting line 7 is closed by the left sealing 6b, and the right pocket coil spring is closed by the right sealing, so that the coil springs are prevented from popping out even when the cutting line 7 is cut.

If the right sealing 6a and the left sealing 6b are not made, when the cutting line 7 is cut, either of the adjacent pockets bursts and the coil spring in the pocket pops out.

According to the conventional method, to prevent popping-out of a coil spring described above, as shown in FIG. 8 and FIG. 10, a pocket 4 that contains no coil spring is formed and a center thereof is set as a cutting line 7 to prevent popping-out of the coil spring, however, this method has a great disadvantage such that the material is wasted and the production efficiency lowers, however, the present invention has solved these problems at one time.

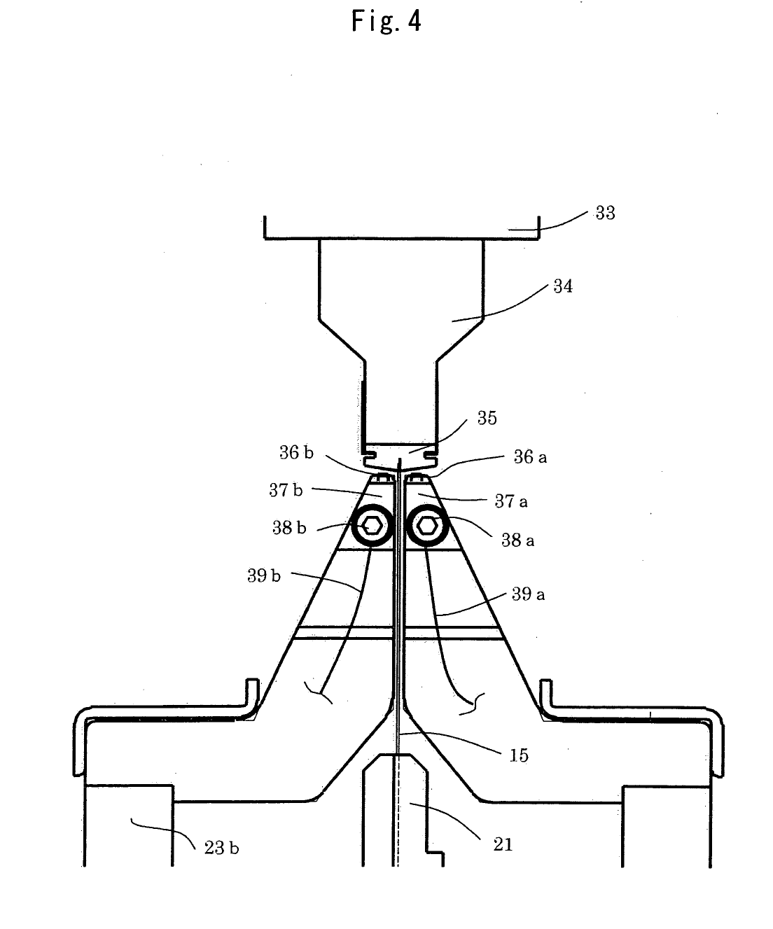

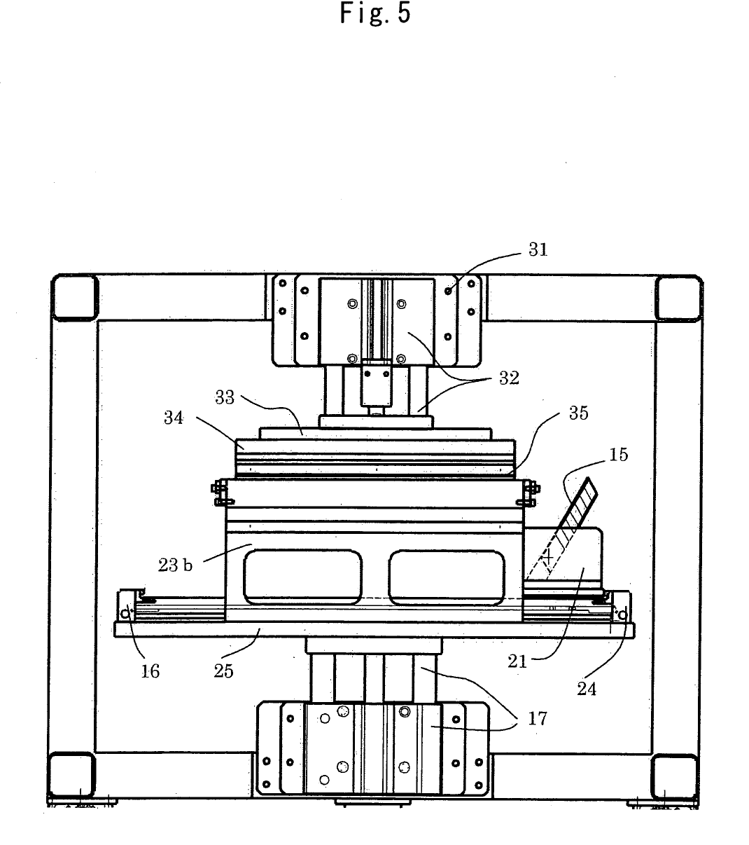

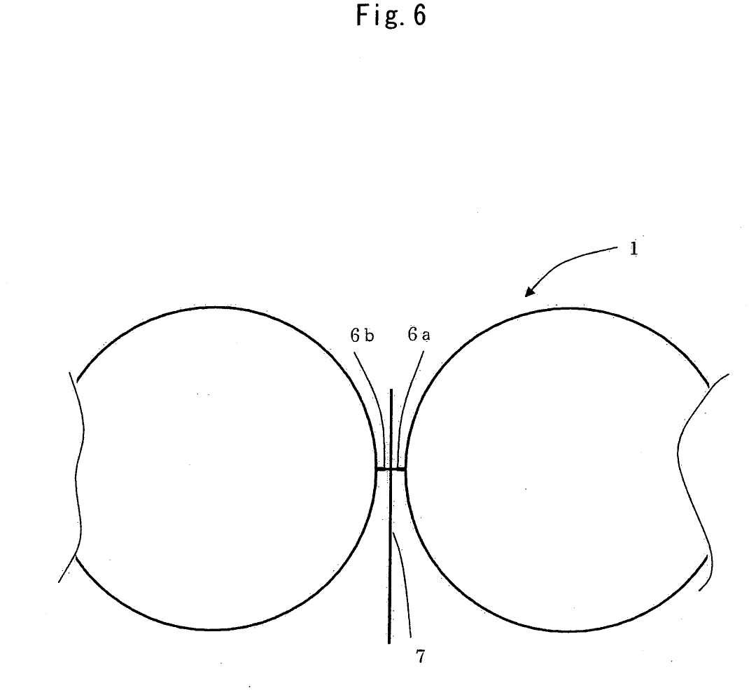

FIG. 4 and FIG. 5 are schematic views of an impulse sealing method which uses an impulse heat sealing method instead of ultrasonic sealing.

According to this method, impulse heater wires 36a and 36b are disposed on the upper surfaces of the right anvil 37a and the left anvil 37b, respectively, and by these impulse heater heats, the right sealing 6a and the left sealing 6b are formed, and other structures are substantially the same as those of the ultrasonic sealing method described above, so that description thereof is omitted.

What is claimed is:

1. A sealing and cutting device for a pocket coil row for sealing and cutting a serial pocket coil row formed in a row in which coil springs are housed one by one in each of connected cylinders in pocket shapes made of nonwoven cloth or fabric every arbitrarily preset number of cylinders, comprising: sealing means for double-sealing, cutting means for cutting a portion between the double seals by moving a cutting blade, and conveying means for conveying the pocket coil row.

2. The sealing and cutting device for a pocket coil row according to claim 1, wherein the sealing means is an ultrasonic welder having a horn with a narrow groove for passage of a cutting blade.

3. The sealing and cutting device for a pocket coil row according to claim 1, wherein the sealing means is provided with an impulse heater wire on both sides of a cutting blade running line.

4. The sealing and cutting device for a pocket coil row according to claim 2, wherein a converter horn of the ultrasonic welder has a mechanism which moves up and down by about ½ or more of the coil spring diameter.

5. The sealing and cutting device for a pocket coil row according to claim 2, wherein the ultrasonic welder includes an upper die and a lower die, and the lower die has a mechanism which moves up and down by about ½ or more of the coil spring diameter.

6. The sealing and cutting device for a pocket coil row according to claim 2, wherein the ultrasonic welder includes an upper die and a lower die, and the lower die is divided into two and the cutting blade is movable at the dividing center.
